(19) United States
(12) Patent Application Publication
(10) Pub. No.: US 2007/0019311 A1
(43) Pub. Date: Jan. 25, 2007

(54) Semi-interactive driving simulator with multiple simulated mirror images and method of preparing images for use in simulator

(75) Inventor: Michael P. Stricek, Binghamton, NY (US)

Correspondence Address: BROWN & MICHAELS, PC;400 M & T BANK BUILDING, 118 NORTH TIOGA ST, ITHACA, NY, 14850, US

(73) Assignee: Doron Precision Systems, Inc., Binghamton, NY (US)

(21) Appl. No.: 11/187,151

(22) Filed: Jul. 22, 2005

(51) Int. Cl. G02B 5/10

(52) U.S. Cl. 359/864

(57) ABSTRACT

A semi-interactive driver training simulator in which the projected image contains simultaneous synchronized front view and side-view mirror images, in which the side-view mirror images have both large “flat” mirror and smaller “convex” images. To create the projected image, five separate cameras are mounted on a real vehicle, and used to take five views simultaneously—a front driver's view, upper “normal” left and right rear views and lower “wide angle” rear views. The two lower cameras are equipped with wide-angle lenses which simulate the convex mirrors used on real vehicles. The five images are separately recorded, with each video stream time-stamped. The time stamps are used to electronically combine the five images into the single synchronized image which is recorded for projection.

### BACKGROUND OF THE INVENTION

1. Field of the Invention

The invention pertains to the field of semi-interactive driving simulators. More particularly, the invention pertains to driving simulators which have multiple mirrors.

2. Description of Related Art

Driving simulators which are used to simultaneously instruct multiple students, each in his or her own simulated “auto” have been known for many years. Early driving simulators consisted of little more than a film projector and a number of desks with steering wheels and foot pedals, where the students “drove” along with the picture on the screen as various driving scenarios were presented.

As technology progressed, the driving stations became more sophisticated, among other things providing feedback to the instructor on the performance of each student. These simulators are known as “semi-interactive” simulators, since the students interacted with the system, but did not change the projected images as would happen in a single-user fully interactive simulator.

U.S. Pat. No. 2,870,548 “Driver Training and Testing Equpment” is a 1959 semi-interactive training system where student reactions are logged for review.

U.S. Pat. No. 3,898,746, “Driver Training System”, shows a semi-interactive driver training simulator with feedback from the students to the instructor's computer.

The applications for such simulators expanded from “Driver Ed” classes in schools to truck and bus operators, where the semi-intereactive simulators have proven to be an effective means of recurrent training and accident reduction.

As the use of semi-interactive trainers have extended into the larger vehicle applications, users became aware of a need to increase the training opportunities by adding rear- or side-view “mirror” images to the simulation.

U.S. Pat. No. 2,935,794, “Automobile Driver Training and Testing Apparatus”, shows a group driver-training simulator with a real mirror attached to the back of each “vehicle”—the student can look in the mirror, which reflects a rear-facing image in the front projector screen to simulate “looking over the shoulder as for lane changes.”

U.S. Pat. No. 4,846,686, “Motor Vehicle Simulator with Multiple Images”, shows a semi-interactive simulator with side-view “mirror” images on each side of the main projected image showing a rear-facing view. The simulator shown in this patent used a film projector, as was the state of the art at the time. As can be seen in FIG. 4, the side-view images (41LM-45LM), (41RM-45RM) are photographically composited using conventional photographic darkroom techniques with the main forward image (41POV-45POV) on each frame (41-45) of the film.

As technology has progressed, commercial trainers have replaced the film and film projectors used in earlier semi-interactive simulators with electronic projectors showing imgages from videotape and, most recently, digital video recording technologies such as video disk and DVD.

Trainers have also become aware in recent years that it is important that the use of mirrors is increasingly of concern to large vehicle operators and insurers, and it is important that the simulation should emulate the real mirrors used on these vehicles as closely as possible. Most trucks and buses use not just one side-view mirror on each side, but two—a large flat mirror, as was simulated in U.S. Pat. No. 4,846,686, and also a smaller convex (wide-angle) mirror underneath the main mirror. Simulators have typically not shown these convex mirrors.

### SUMMARY OF THE INVENTION

The invention comprises a semi-interactive driver training simulator in which the projected image contains simultaneous synchronized front view and side-view mirror images, in which the side-view mirror images have both large “flat” mirror and smaller “convex” images.

To create the projected image, five separate cameras are mounted on a real vehicle, and used to take five views simultaneously—a front driver's view, upper “normal” left and right rear views and lower “wide angle” rear views. The two lower cameras are equipped with wide-angle lenses which simulate the convex mirrors used on real vehicles. The five images are separately recorded, with each video stream time-stamped. The time stamps are used to electronically combine the five images into the single synchronized image which is recorded for projection.

### BRIEF DESCRIPTION OF THE DRAWING

FIG. 1 shows the semi-interactive simulator of the invention

FIG. 2 shows a side view of a tractor-trailer truck equipped to take pictures according to the method of the invention

FIG. 3 shows a top view of a tractor-trailer truck equipped to take pictures according to the method of the invention

FIG. 4 shows a photograph of an actual truck, as used in the method of the invention

FIG. 5 shows a diagram of the apparatus used in the method of the invention

FIGS. 6a-6e shows a video sequence of a car passing the simulated truck on the left.

FIG. 7a-7e shows a video sequence of a car passing the simulated truck on the right.

### DETAILED DESCRIPTION OF THE INVENTION

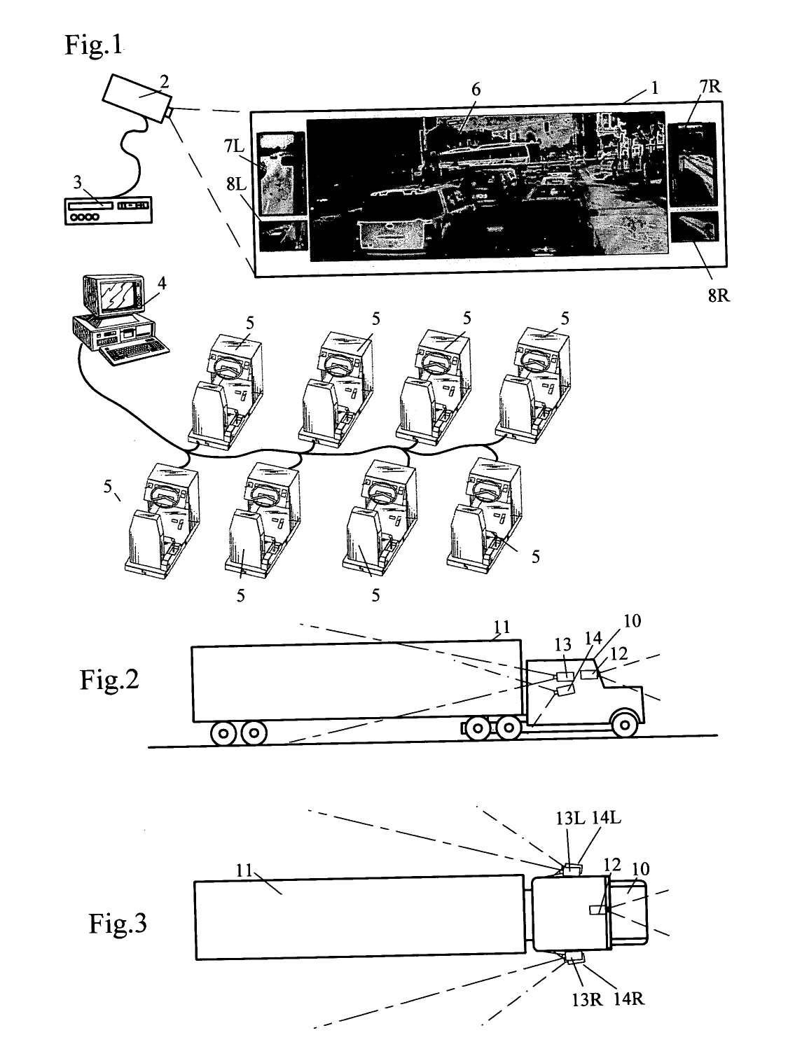

FIG. 1 shows a semi-interactive driving simulator of the invention.

A number of simulator stations (5) each have steering wheels, drivers seats and dashboards appropriate to the kind of vehicle being simulated. They are connected to a central computer (4) which record the students' reactions, may drive the gauges in the driving stations, and also acts as an instructor's console for controlling the system. A video source (3), preferably a DVD player, drives a video projector (2) to project the driving image on a large screen (1) in front of the simulator stations (5).

As can be seen in FIG. 1, the projected image attempts to simulate the actual driving experience of a large over-the-road vehicle such as a truck or bus by having a front driver's view image (6), and simulated side-view mirrors (7L/R) and (8L/R). The mirror images are synchronized with the main image (6).

The upper mirrors (7L/R) show a “normal” undistorted view, while the lower mirrors (8L/R) provide wide-angle images which simulate the convex mirrors on a real bus or truck. The reason for this can clearly be seen in the left-hand mirrors in FIG. 1, where the upper mirror (7L) appears to show the lanes to the left of the truck as being clear, but a car can be seen in the lower mirror (8L). This trains the drivers to look at both mirrors for critical safety information, which would be lacking in prior art simulators such as U.S. Pat. No. 4,846,686, which would only show the empty road of the upper mirrors.

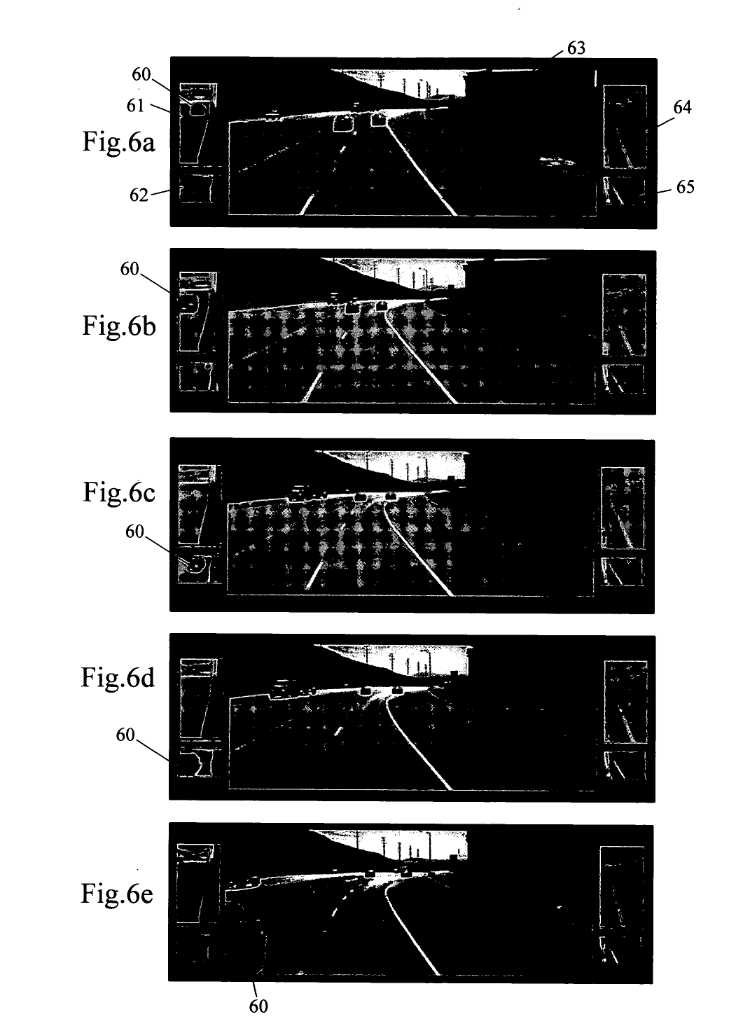

FIGS. 6a to 6e show how the invention is used to train drivers what to look for in a typical scenario, in sequential frames taken from an actual training video of the invention. The truck is driving along a relatively open rural highway. The screen shows the forward view (63), as the driver would see looking out his windshield. The left-hand mirrors (61) and (62) show the rear view to the left, the right-hand mirrors (64) and (65) show the view to the right. In the first frame (FIG. 6a) car (60) can be seen in upper left-hand mirror (61) overtaking the truck from the left and rear. The car begins to pass the truck (FIG. 6b), and appears alongside in mirror (61). It also appears, much smaller, in the wide-angle view of lower mirror (62). In FIGS. 6c and 6d, the car approaches and passes alongside the cab of the truck—it has disappeared from mirror (61), but is now visible in lower wide-angle mirror (62). Finally, in FIG. 6e, the car has passed, and appears in the windshield view.

FIGS. 6c and 6d illustrate the dangerous situation where the truck driver might be tempted to move left and collide with the car (60), if he is not trained to look at both mirrors—a situation which prior art simulators, which did not show the wide-angle view, could not provide.

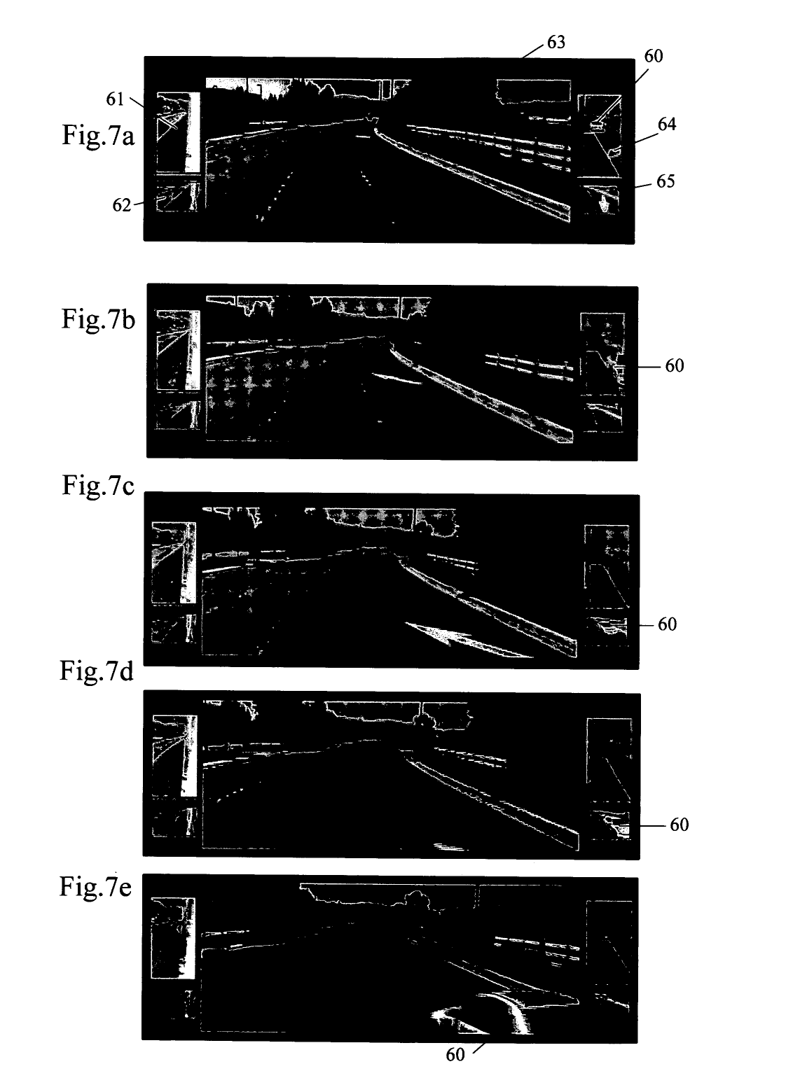

FIGS. 7a-7e show an even more dangerous situation, on a narrowing smaller road where the right lane disappears and traffic is expected to merge left. A car (60) approaches on the right in FIG. 7a, and can be seen in upper right mirror (64). Instead of falling back behind the truck, the driver of the car decides to try to pass on the right. In FIGS. 7b through 7d, it can be seen that the car (60) appears, and then disappears in upper right mirror (64), but still can be seen in lower wide-angle mirror (65) throughout the sequence. Finally, in FIG. 7e, the car cuts the truck off from the right as the right lane ends, and it appears in the windshield image (63). Again, as in the FIG. 6a-e sequence, without the lower mirror images (65), the driver would not see the car at all until it was too late.

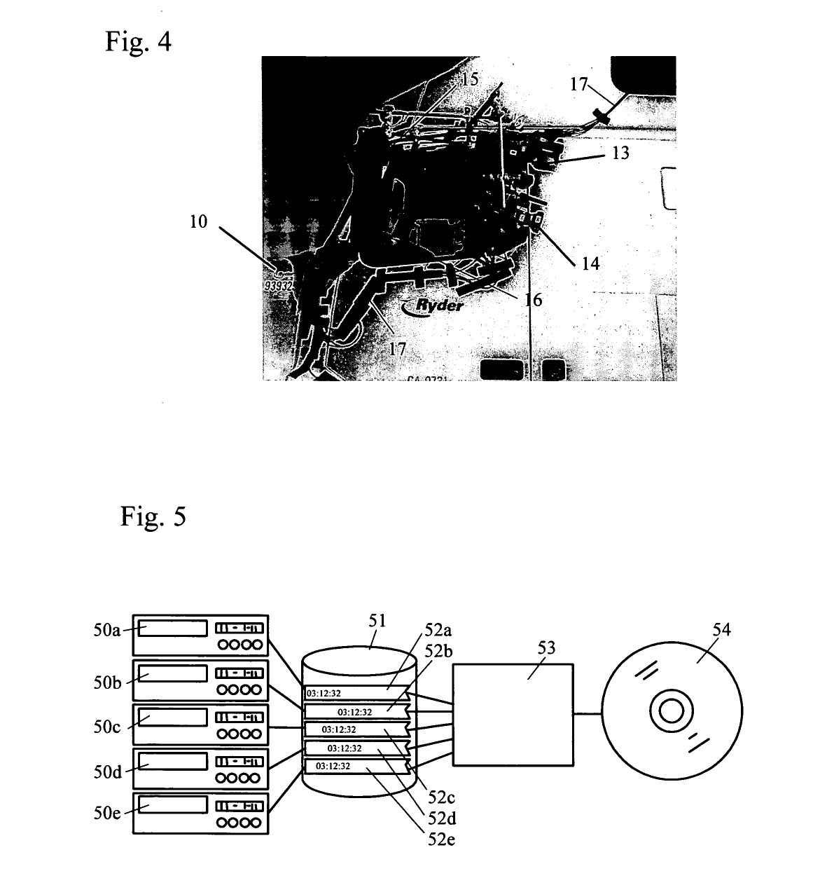

FIGS. 2 through 4 show how the images are taken. Five cameras are mounted on an actual tractor (10) and trailer (11) rig, so that the projected images will include parts of the vehicle for maximum realism. A forward-view camera (12) is mounted in the cab (10), looking out the windshield, to give the driver's view. Upper cameras (13L/R) are mounted on the left and right sides of the cab (10), pointed backward roughly parallel to the ground, or slightly downwardly tilted—paralleling the view of the actual upper truck mirrors (15). The upper cameras are equipped with “normal” focal length lenses (i.e., they neither enlarge nor reduce the visual image). This arrangement of three cameras is the same one shown in U.S. Pat. No. 4,846,686, except that the cameras are video cameras instead of the film cameras used in that older patent. The invention adds two more cameras, lower cameras (14L/R). These cameras are more steeply inclined downward, and have wide-angle lenses to simulate the wide-angle view of the convex curved mirrors (16) in a real truck or bus. The cameras can be connected by power and video lines (17) to recorders in the truck cab, or can have internal recording means, so that the views can be recorded separately and simultaneously. As the video stream from each camera is taken, each frame is coded with the time (“time stamped”).

Referring to FIG. 5, the tapes or discs from the cameras are played back and captured digitally. This playback is shown schematically as five separate playback machines (50a)-(50e), but it will be understood that the video can be played and captured sequentially on a single player. Each video stream is saved as a separate file (52a)-(52e) on a storage medium such as a disc drive (51). As can be seen on the block diagram of FIG. 5, the streams are probably not truly synchronized at this point, since each video recorder will inevitably be started at a slightly different time. However, with each frame time-stamped, the video streams can be electronically synchronized by coupling the frames from each video stream which have the same time stamp, using an appropriately programmed computer and software (53) to combine the five separate streams into a single synchronized video image as shown and discussed above. This combined video stream is saved to a storage medium (54), preferably DVD in current technology or a solid state storage device, for use in the invention.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An improved semi-interactive simulator system of the type having a plurality of driver stations coupled to an instructor's station and computer, a source of video images comprising at least a forward driver's view from a vehicle, and a projector for projecting the video images upon a screen, in which the improvement comprises:
the projected video images comprise, in addition to the forward driver's view, four rearward facing views simulating side-view mirrors:
on a left side and a right side of the forward driver's view, a rearward view simulating a view through a flat side-view mirror, and
on the left side and the right side of the forward driver's view, adjacent to the rearward view simulating the flat side-view mirror, a wide-angle rearward view simulating a view through a convex side-view mirror;
the video images comprising the forward driver's view, simulated right flat mirror, simulated left flat mirror, simulated right convex mirror and simulated left convex mirror being synchronized such that the five images simulate the view from the cab of an actual vehicle through the windshield and the side-view mirrors.

2. The system of claim 1, in which the images are actual photographic images recorded by a plurality of cameras mounted on an actual vehicle.

3. The system of claim 2, in which the cameras recording the simulated flat side-view mirrors are mounted on the vehicle substantially parallel to the vehicle.

4. The system of claim 2, in which the cameras recording the simulated convex side-view mirrors are mounted on the vehicle pointed downward from a line parallel to the vehicle.

5. The system of claim 2, in which the camera recording the forward driver's view is mounted in the cab of the vehicle, viewing through a windshield.

6. The system of claim 2, in which the images recorded by the plurality of cameras are time-stamped during recording.

7. The system of claim 6, in which the time-stamps on the images are matched to synchronize the projected video images.

8. The system of claim 2, in which the photographic images are recorded digitally.

9. The system of claim 1, in which the video images are recorded upon DVDs and the source of video images is a DVD player.

10. The system of claim 1, in which the video images are stored on a storage medium in the computer, and a video output from the computer is the source of video images.

11. A method of producing images for projection in a semi-interactive simulator system, comprising the steps of:
mounting a plurality of cameras on an actual vehicle, the cameras comprising:
a camera pointed forward to capture a forward driver's view
on each of a left side of the vehicle and a right side of the vehicle,
a camera facing rearward to capture a view simulating a view through a flat side-view mirror, and
adjacent to the camera capturing rearward view simulating the flat side-view mirror, a camera having a wide-angle lens, capturing a rearward view simulating a view through a convex side-view mirror;
recording the views from each of the plurality of cameras in a separate video stream as the vehicle is driven, each of the video streams being time-stamped during recording;
after the images are recorded, transferring the time-stamped video streams to a storage medium;
combining the video streams on the storage medium into a composite video image showing a simulated view comprising the forward driver's view, simulated right flat mirror, simulated left flat mirror, simulated right convex mirror and simulated left convex mirror, the video streams being synchronized using the time stamps, such that the five images simulate the view from the cab of an actual vehicle through the windshield and the side-view mirrors.

12. The method of claim 11, in which the cameras recording the simulated flat side-view mirrors are mounted on the vehicle substantially parallel to the vehicle.

13. The method of claim 11, in which the cameras recording the simulated convex side-view mirrors are mounted on the vehicle pointed downward from a line parallel to the vehicle.

14. The method of claim 11, in which the camera recording the forward driver's view is mounted in the cab of the vehicle, viewing through a windshield.

15. The method of claim 11. in which the views are recorded digitally.

16. The method of claim 11, further comprising the step of recording the composite video image to a video storage medium.

17. The method of claim 16, in which the video storage medium is DVD.

18. The method of claim 16, in which the video storage medium is a computer disk.

19. The method of claim 16, in which the video storage medium is solid state storage device.
